(19) United States
(12) Patent Application Publication
(10) Pub. No.: US 2019/0133149 A1
(43) Pub. Date: May 9, 2019

(54) STABILIZATION OF FROZEN AERATED CONFECTION

(71) Applicant: NESTEC S.A., Vevey (CH)

(72) Inventors: Michael Dennis Sharp, Bakersfield, CA (US); Rajiv Indravadan Dave, Bakersfield, CA (US)

(21) Appl. No.: 16/099,737

(22) PCT Filed: May 11, 2017
(86) PCT No.: PCT/EP2017/061380

§ 371 Date: Nov. 8, 2018

Related U.S. Application Data
(60) Provisional application No. 62/336,180, filed on May 13, 2016.

(51) Int. Cl. A23G 9/34; A23G 9/20; A23G 9/46

(52) U.S. Cl. CPC A23G 9/34; A23V 2002/00; A23G 9/46; A23G 9/20

(57) ABSTRACT

The present invention relates to a stabilizer system of natural ingredients for use in frozen aerated confection, the stabilizer system comprising 0.25-2.0 wt. %, preferably 0.30-1.5 wt. % of tapioca starch, and 0.05-0.40 wt. %, preferably 0.1-0.25 wt. % pectin. The invention further relates to the use of such a system and a frozen confection comprising the stabilizer system and the method of manufacturing the frozen confection.

### FIELD OF INVENTION

The present invention relates to a stabilizer system of natural ingredients for use in frozen aerated confections, in particular to a stabilizer system comprising tapioca starch and pectin. The invention also relates to a frozen aerated confection comprising such a stabilizer system and a method of making it and its use.

### BACKGROUND OF INVENTION

In the manufacturing of frozen confection stabilizers are generally used for functional purposes such as improvement of smoothness, prevention of ice crystal formation in storage, improvement of handling properties, while the use of emulsifiers results in small air cells which are evenly distributed in the product.

These ingredients are indispensable to the manufacture of acceptable commercial products. Efficient stabilizers/emulsifiers systems already exist but these are often chemically modified products. Consumers prefer products with more natural ingredients. There is thus a need for providing systems which are more natural and efficient.

One potential defect seen in frozen confections is barometric shrinkage, where the air cells collapse resulting in a loss of volume and texture in the container. For high overrun products the problem becomes increasingly pronounced during distribution when the product subjected to barometric pressure change which is the case when the product is transported across higher altitudes. Further, the barometric shrinkage changes the texture of the product and makes it harder and colder.

There is a need to provide a frozen confection being produced with high overrun and without artificial emulsifiers and stabilizers which overcome the aforementioned drawbacks.

### OBJECT OF THE INVENTION

It is thus the object of the present invention to provide a stabilizer system which can be used in the manufacture of all-natural frozen aerated confection. Furthermore, there is a need for an all-natural frozen aerated confection which is resistant to barometric shrinkage.

### SUMMARY OF THE INVENTION

It was surprisingly found that frozen aerated confection according to the invention showed an overrun stability at the freezer and barometric shrinkage resistance. This enables the manufacturer to deliver a consistent product quality to the consumer even when shipped at different heights above sea level. It has further been found that the stabilizer system has no impact on flavours in the amounts necessary to stabilize the frozen confection.

In a first aspect, the present invention relates to a stabilizer system of natural ingredients for use in frozen confection, the stabilizer system comprising 0.25-2.0 wt. %, preferably 0.30-1.5 wt. % of tapioca starch, and 0.05-0.40 wt. %, preferably 0.1-0.25 wt. % pectin.

Tapioca starch is known to be used as a bulking agent in fruit preparation and sauces. It has also been used in frozen confection as a bulking agent. Its functional role in stabilizing frozen aerated confection through barometric pressure change is novel. It has surprisingly been found that tapioca starch in combination with pectin can replace traditional non-natural stabilizer systems typically comprising of mono- and diglycerides. The air-cell stability is shown in microstructure pictures in FIGS. 1A and 1B.

In a second aspect, the invention relates to the use of the stabilizer system in the manufacturing of frozen confections, in particular to prevent barometric shrinkage resistance in frozen confection.

In further aspects, the invention relates to a frozen aerated confection comprising a stabiliser system comprising 0.25-2.0 wt. %, preferably 0.30-1.5 wt. % of tapioca starch, and 0.05-0.40 wt. %, preferably 0.1-0.25 wt. % pectin, and a method of manufacturing it.

### BRIEF DESCRIPTION OF THE DRAWINGS

FIGS. 1A and 1B are confocal microscopic pictures of products with different amounts of tapioca starch and pectin.

### DETAILED DESCRIPTION

Tapioca is a starch extracted from cassava root. This species is both native and cultivated. Tapioca starch is known to be used as a bulking agent for fruit preparation and sauces.

Further in the present context unless otherwise indicated % of a component means the % of weight based on the weight of the composition, i.e. weight/weight %.

By “frozen aerated confectionery product” is meant any aerated product such as ice cream, sorbet, mellorine, milk shake, any frozen dessert etc.

The products of the invention may be aerated to an overrun of preferably at least 40%, more preferably at least 90%. In a preferred embodiment, the overrun is up to 150%. Most preferably, the overrun is 100-126%.

By “stabiliser system” is to be understood a mixture of ingredients which contributes to the stability of the frozen product with respect to ice crystal formation, heat shock resistance, overall texture properties etc. Thus, the stabiliser system may comprise any ingredients which are of structural importance to the frozen confectionery. This stabiliser system may comprise ingredients which render the texture creamier, or natural emulsifying ingredients which overall contribute to the advantageous textural, structural, organoleptic properties of the product.

The stabiliser system of the invention is particularly advantageous as it allows the manufacture of stable frozen confectionery without resorting to artificial ingredients such as stabilisers and emulsifiers traditionally used in the art.

The stabilizer system according to the invention is of natural ingredients and for the use in frozen confection, the stabilizer system comprising 0.25-2.0 wt. %, preferably 0.30-1.5 wt. % of tapioca starch, and 0.05-0.40 wt. %, preferably 0.1-0.25 wt. % pectin. A particular preferred stabilizer system consist of tapioca starch and pectin.

The stabilizer system is advantageously used in the manufacturing of frozen aerated confection.

It has been found that the use of the stabilizer system in frozen aerated confection can prevent shrinkage of frozen aerated confection subject to barometric pressure variations and temperature variation (heat shock).

In one embodiment of the invention relates to a frozen aerated confection comprising a stabiliser system comprising 0.25-2.0 wt. %, preferably 0.30-1.5 wt. % of tapioca starch, and 0.05-0.40 wt. %, preferably 0.1-0.25 wt. % pectin.

It has been found that tapioca starch at a level of 1 wt. % provides for a good air incorporation in the frozen confection and low overrun variability at the freezer although at levels as low as 0.25 wt. % and as high as 2.0 wt. % tapioca starch it was possible to incorporate an overrun of 95% to 135%.

Tapioca starch has been found to have a significant effect on barometric shrinkage resistance. The effect is seen with an amount of tapioca starch as low as 0.25 wt. %, however a level of 0.05 wt. % pectin is needed in order to obtain this effect. It is believed that the tapioca starch and pectin provides a synergetic effect. Pectin alone, or tapioca starch at level below 0.25 wt. % does not provide any protection against barometric shrinkage.

It has been found that with an amount of above 2.0 wt. % tapioca starch and above 0.40 wt % pectin the aerated frozen confection becomes too viscous and thus cause high pressures in the pasteurizer. Preferably the frozen confection comprises from 0.25 to 0.40 wt % pectin.

Without wishing to be bound by theory, it is believed that because tapioca starch has a high ratio of amylopectin to amylose compared to other common native starches such as corn, the amylopectin in the tapioca starch causes a phase separation which leads to aggregation of the proteins in a matrix causing rigidity and stability of the system. The formation of this structure and the protection against barometric shrinkage seem to be correlated. Pectin is believed to have a much greater effect on ice cream texture than tapioca starch. Ice cream with higher levels of pectin were found to be less icy, less cold, and slower melting.

A combination of Tapioca starch and pectin in the amount according to the invention allows for good air stability at the freezer during manufacturing and through barometric pressure changes through distribution, as well as providing optimum texture through the shelf life of the product.

It is preferred that the frozen aerated confection according to the invention has 35-45 wt. % solid content and 95 to 135%, preferably 100 to 126% overrun. Below 35 wt. % the product has an icy texture and above 45 wt. % the product mix is be viscous for standard ice cream production.

It is preferred that the tapioca starch is native. Native tapioca starch means tapioca starch which has not undergone any chemical modifications. Native tapioca starch is usually referred to as natural starch on the product label.

The frozen aerated confection according to the invention can be free-of or made without artificial or non-natural emulsifier or stabilizer. The frozen aerated confection can also be free of egg. In a preferred embodiment of the invention the frozen aerated confection consist of only natural ingredients.

In a particular preferred embodiment of the invention the frozen aerated confection has a stabiliser system which consists of tapioca starch and pectin only.

It is preferred that the frozen aerated confection has a fat content of 3.0-11.0 wt. %, preferably 5.5 to 10.5 wt. % fat. Below 3.0% the product may not have sufficient fat to stabilize air, while above 11.0% there is sufficient fat in the product to stabilize the incorporated air.

By “natural ingredients” are meant ingredients of natural origin. These include ingredients which come directly from the field, animals, etc. or which are the result of a physical or microbiological/enzymatic transformation process. These therefore do not include ingredients which are the result of a chemical modification process.

Examples of non-natural ingredients which are avoided in the present invention include for example mono- and diglycerides of fatty acids, acid esters of mono- and diglycerides of fatty acids such as acetic, lactic, citric, tartaric, mono- and diacetyl tartaric acid esters of mono- and diglycerides of fatty acids, mixed acetic and tartaric acid esters of mono- and diglycerides of fatty acids, sucrose esters of fatty acids, polyglycerol esters of fatty acids, polyglycerol polyricinoleate, polyethylene sorbitan mono-oleate, polysorbate 80, chemically extracted lecithin. The non-natural ingredients are not present in the product according to the present invention.

Chemically modified starches which are used in the art as stabilisers are also avoided. These include for example oxidised starch, monostarch phosphate, distarch phosphate, phosphated or acetylated distarch phosphate, acetylated starch, acetylated distarch afipate, hydroxy propyl starch, hydrosypropyl distarch phosphate, acetylated oxidised starch.

The use of natural products as stabilisers in low-temperature extruded products is particularly challenging due to the requirements of low-temperature extrusion processes and the wide range of overrun which is desired.

Surprisingly, it was found that the stabiliser system works particularly well at overruns of 95 to 135%, preferably 100 to 126% overrun.

In the present context the term “sugars” in this document will be defined as a mixture of mono- and di-saccharides. For example, sucrose, glucose, fructose, maltose are sugars according to this definition. Moreover, the term “sugar” will be defined as dry sucrose, or common sugar, or crystallized sugar. Typical amounts of sugar is 13-19 wt. % sugar.

The frozen confection product according to the present invention may comprise one or more proteins. Typical sources of proteins are skim milk, whey protein concentrate; acid casein; sodium caseinate, acid whey, whey protein isolate, sweet whey, demineralized sweet whey, demineralized whey, milk protein concentrate or mixtures thereof. The protein(s) may be selected from any dairy protein and plant protein.

In a preferred embodiment of the present invention, the protein is a dairy protein. The protein may also be a plant protein such as soya protein, pea protein, wheat protein, corn protein, and rice protein, proteins from legumes, cereals and grains in general. The protein may also be protein isolates from nuts or seeds.

In another embodiment of the present invention, the protein includes a partially coagulated protein system including kappa-casein and beta-lactoglobulin.

The term “partially coagulated protein system” is to be understood to mean a complex or an aggregate resulting from at least a partial coagulation of proteins present in the ingredient mix, for instance induced by the presence of an acidifying agent combined with a heat treatment.

Most milk proteins (mainly caseins) in their native state remain in colloidal suspension form leading to minimal changes in mix viscosity (˜200-400 cp). However, when proteins are subjected to controlled exposure to known amounts of heat and acid (e.g., pH of 6.1 or less and pasteurization) they undergo denaturation. Protein denaturation is a state of unfolding, where the proteins are hydrated resulting in a three dimensional network (soft gel) causing increased mix viscosity (˜199-2400 cp). If the exposure of proteins to heat and acid is not controlled, this phenomenon could lead to precipitation (e.g. syneresis in yoghurt).

It has been found that adding tapioca starch and pectin in a combination according to the invention to a frozen confection mix including a partially coagulated protein system, for example addition of an acidifying agent to an ice cream mix comprising dairy proteins, a product with improved sensorial properties is obtained as compared to products only comprising an acidifying agent and no tapioca starch and pectin and as compared to products with tapioca starch and pectin in the amounts according to the invention but no acidifying agent added.

Without being bound by any theory, it is believed that partial denaturation of proteins within the ice cream mix is providing freshly aggregated proteins that act as a natural stabilizer for the air cells and enable creation of a very fine and stable microstructure resulting in a smooth, rich and creamy product without the use of artificial emulsifiers or stabilizers or similar additives. This makes the products more natural and desirable for consumers who wish to minimize their intake of such artificial additives.

In particular, the synergistic effect of the freshly aggregated proteins obtained by addition of tapioca starch and pectin, and preferably in combination with a pH adjusting agent (acidifying agent), obtained in combination with low temperature freezing technology is therefore leading to superior products in terms of texture and stability.

Preferably, the proteins are dairy proteins which are usually present in an ice cream mix and which comprises casein, whey proteins, whey protein concentrate, whey protein isolate or sweet whey or the combination thereof. Such proteins may undergo partial aggregation.

### pH Adjusting Agent

According to a particular embodiment of the invention, the pH is controlled by the presence of a pH adjusting agent. The pH adjusting agent may for example be molasses, an edible organic acid such as citric acid, acetic acid, lactic acid, malic acid, ascorbic acid, benzoic acid, fumaric acid, lactones such as glucono-delta-lactone, fruit derived acids and fermentation derived acids.

The pH adjusting agent will as discussed above result in coagulation or aggregation of the proteins present in the ingredient mix for preparing the frozen confection product. The pH adjusting agent is added in an amount such as to obtain a pH in the products in the range of 5.0 to 6.5, preferably in the range of 5.1 to 6.3, such as in the range of 5.3 to 6.0, even more preferably in the range of 5.4 to 5.9, such as in the range of 5.5 to 5.8.

When the protein system is partially denatured prior to addition to the other components, the pH can be as high as 6.4 without detracting from the organoleptic properties of the product.

When using tapioca starch and pectin in combination with a pH adjusting agent such as organic acids, preferably glucono-delta-lactone, an increased aggregation of protein will be obtained as compared to products only comprising either tapioca starch and pectin or a pH adjusting agent. By protein aggregation the large milk proteins structure in an ice cream mix is broken into smaller proteins, i.e. the proteins are un-folded. These unfolded proteins have the ability to increase the water holding capacity and form a unique 3-D network, i.e. trap water and small fat particles inside them. This results in increasing mix viscosity and making an ice cream mix which is thick and viscous when extruded through the Low Temperature Freezer (LTF), and which helps the ice cream product to attain a unique smooth and creamy texture that mimics the presence of higher fat levels.

In another embodiment of the invention, the frozen confection product comprises a pH adjusting agent in an amount of 0.05 to 2.0% by weight, preferably in an amount of 0.06 to 1.0%, such as 0.07 to 0.8%, even more preferably in an amount of 0.1 to 0.3% by weight.

In a further embodiment the invention relates to a method for the manufacture of a frozen aerated confectionery according as discussed above comprising the steps of:
a) providing an ingredient mix comprising 0.25-2.0 wt. %, preferably 0.30-1.5 wt. % of tapioca starch, and 0.05-0.40 wt. %, preferably 0.1-0.25 wt. % pectin, and having a 35-45 wt. % solid content,
b) homogenising the mix,
c) pasteurising the mix,
d) freezing and aerating the mix to 95 to 135%, preferably 100 to 126% to form a frozen confection, and
e) optionally hardening the mix.

In a preferred embodiment of the invention the ingredient mix further comprises a pH adjusting agent to obtain a pH in the range of 5.0 to 6.5. The pH adjusting agents are discussed above. The pH adjusting agent is preferably added to the mix after the homogenisation.

In an embodiment according to the present invention, the freezing in step e) is made by using a standard continuous industry freezer.

In a preferred embodiment of the invention, the primary freezing step in step e) is followed by a low temperature freezing process. The low temperature freezing, may also be termed low temperature extrusion, is reducing the product temperature to below −11° C., preferably between −12° C. and −18° C. The screw extruder may be such as that described in WO 2005/070225. The extrusion may be performed in a single or multi screw extruder.

Preferred pasteurization conditions include heating to a temperature between 75° C. to 90° C., such as between 80° C. to 90° C., even more preferably between 83° C. to 87° C. for a period of 30 to 120 seconds, preferably from 30 to 60 seconds.

Homogenisation is preferably done prior to pasteurization. It is preferably carried out under standard conditions, namely at a pressure of between 40 and 200 bars, preferably between 100 and 150 bars, more preferably between 120 and 140 bars.

The homogenised mix may then be cooled to around 2 to 8° C. by known means. The mix may further be aged for 4 to 72 hours at around 2 to 6° C. with or without stirring. Optionally, the addition of flavourings, colourings, sauces, inclusions etc. may be carried out after ageing and before freezing. If flavourings, colourings, sauces, inclusions etc. are added, these are preferably selected from natural ingredients only.

In the next step, the mix is frozen. In an embodiment of the invention the freezing is made while aerating the pasteurized mix. In a preferred embodiment, the mix may be cooled to a temperature below −3° C., preferably between −3 and −10° C., even more preferably between at about −4.5 to −8° C. with stirring and injection of a gas to create a desired overrun.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

### EXAMPLES

By way of example and not limitation, the following examples are illustrative of various embodiments of the present disclosure.

Two set of mixes were made with 1.0% tapioca starch and 0.1% pectin.

| Ingredient | Concentration (% weight) |
|---|---|
| Cream | 12 |
| Skim Milk | 24 |
| Water | 31 |
| Glucose Syrup | 10 |
| Liquid Sucrose | 18 |
| Milk Powder | 2 |
| Native Tapioca Starch | See Matrix |
| Pectin (60% Esterification) | See Matrix |
| Glucono Delta Lactone | 0.1 |

The Final Mix had a target of 5.25% fat, 10.75% SNF.

The mix was pasteurized and homogenized using an HTST (High-temperature, short-time pasteurizing and homogenizing unit). All mixes were preheated to 145° F. (63° C.), then homogenized at 1500 psi first stage 500 psi second stage pressures. The final heating was at 182 F (83° C.) with a 90 second hold time. The mix was then cooled to 45° F. (7° C.) and stored at 40° F. overnight under light agitation.

The mixes were frozen on using a standard freezer (manufactured by WCB Ice Cream) and a low temperature extruder (manufactured by Gerstenberg/KBX 130 ET freezer). The draw temperature for the primary freezer was 20° F. (−7° C.) and 9.0° F. (−13° C.) for the KBX 130 ET freezer. Each ice cream was frozen to 125% overrun

### Barometric Shrinkage:

Filled ice cream containers were placed in glass desiccators and subjected to 5 inHg of vacuum for 1 hour then placed back at ambient pressure for 1 hr repeated 3 times. The pressure-abused ice cream is then placed in a temperature cycling freezer for 24 hrs at a cycles of 11.5 hrs of 0° F. (−18° C.) and 30 minutes of 40° F. (4° C.). The ice cream is then hardened in a −20° F. (−29° C.) freezer overnight and tested for specific volume. The specific volume is then compared with a non-abused container.
Barometric Shrinkage Resistance (<5% is considered acceptable):

| % Pectin | % Starch | % Shrinkage |
|---|---|---|
| 0.00 | 0.00 | 5.87 |
| 0.00 | 1.00 | 3.45 |
| 0.015 | 0.25 | 5.25 |
| 0.015 | 1.00 | 1.79 |
| 0.015 | 2.00 | 2.69 |
| 0.10 | 0.00 | 5.82 |
| 0.10 | 0.25 | 2.46 |
| 0.10 | 1.00 | 0.565 |
| 0.40 | 0.25 | 4.32 |

The tapioca starch had a significant effect on lowering the amount of shrinkage. At the lowest level of tapioca starch (0.25%) the pectin was required at a level of 0.1% or higher.

Tapioca starch above 2.0% and Pectin above 0.4% would be too viscous and cause high pressures at the pasteurizer.

Tapioca starch has a significant effect on barometric shrinkage resistance. The effect can be seen as low as 0.25%, however a level of pectin is needed above 0.015% to have an effect. Pectin alone, does not acceptably protect against barometric shrinkage, but in combination with tapioca starch reduces shrinkage. Pectin has a much greater effect on ice cream texture than tapioca starch. Ice cream with higher levels of pectin were less icy, less cold, and slower melting. To get a desirable texture it has been found that the Pectin should be at least 0.5 wt. %.

### Viscosity:

Mix Viscosity was measured using an Anton Paar rheometer MCR302. Each mix was measured at 40° F. (4.44° C.) using a Concentric cylinder measuring system CC27. The Ostwald-de Waele (power law) model was used for to calculate the estimated viscosity at 0 shear.

### Mix Results:

| | | Viscosity | Discharge |
|---|---|---|---|
| % Pectin | % Starch | (cP) | Pressures (psi) |
| 0.00 | 0.00 | 89 | 71 |
| 0.00 | 1.00 | 255 | 79 |
| 0.015 | 0.25 | 118 | 72 |
| 0.015 | 1.00 | 313 | 78 |
| 0.015 | 2.00 | 1323 | 105 |
| 0.10 | 0.00 | 449 | 85 |
| 0.10 | 0.25 | 848 | 91 |
| 0.10 | 1.00 | 851, 659 | 89, 83 |
| 0.40 | 0.25 | 1334 | 109 |

Both Tapioca starch and pectin increased the viscosity of the mix and discharge pressures. Because the safe limit for the pasteurizer is 110 psi, it is not recommended that to exceed 2.0% Tapioca starch or 0.40% pectin.

Air stability at the freezer (target 125%):

| | | Measured | Standard |
|---|---|---|---|
| % Pectin | % Starch | Overrun | Deviation. |
| 0.00 | 0.00 | 121 | 9.91 |
| 0.00 | 1.00 | 128 | 4.76 |
| 0.015 | 0.25 | 125 | 7.23 |
| 0.015 | 1.00 | 129 | 4.81 |
| 0.015 | 2.00 | 131 | 11.1 |
| 0.10 | 0.00 | 118 | 8.8 |
| 0.10 | 0.25 | 130 | 8.5 |
| 0.10 | 1.00 | 123, 126 | 6.1, 6.5 |
| 0.40 | 0.25 | 130 | 8.3 |

In general there was no significant difference between most of the variables, however some trends were observed. The variables without tapioca starch were not able to obtain the target 125% weight. The variables with 1.00% starch had the lowest standard deviations. The level of pectin did not seem to effect the measured overrun or the standard deviation.

### Particle Size Analysis:

Particle size distribution was measured with a Malvern Mastersizer 3000 particle size analyser. The temperature of the sample were 4.4° C. with the following instrument parameters: No ultrasonic, stirring speed 1700 rpm, Particle refractive index 1.4550, absorbance 0.100, dispersant refractive index 1.3300.

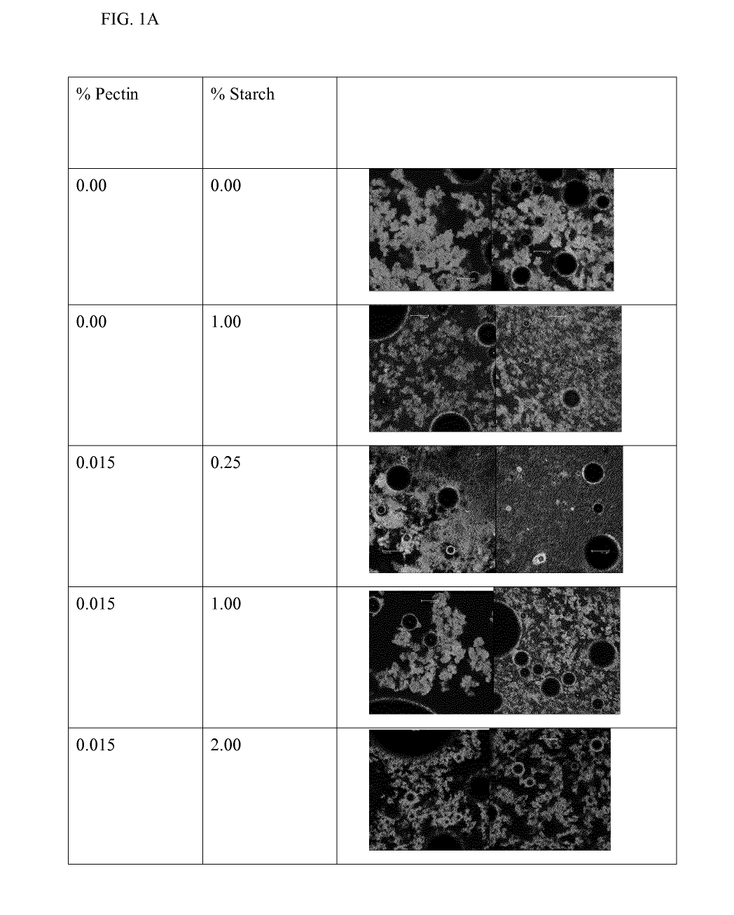

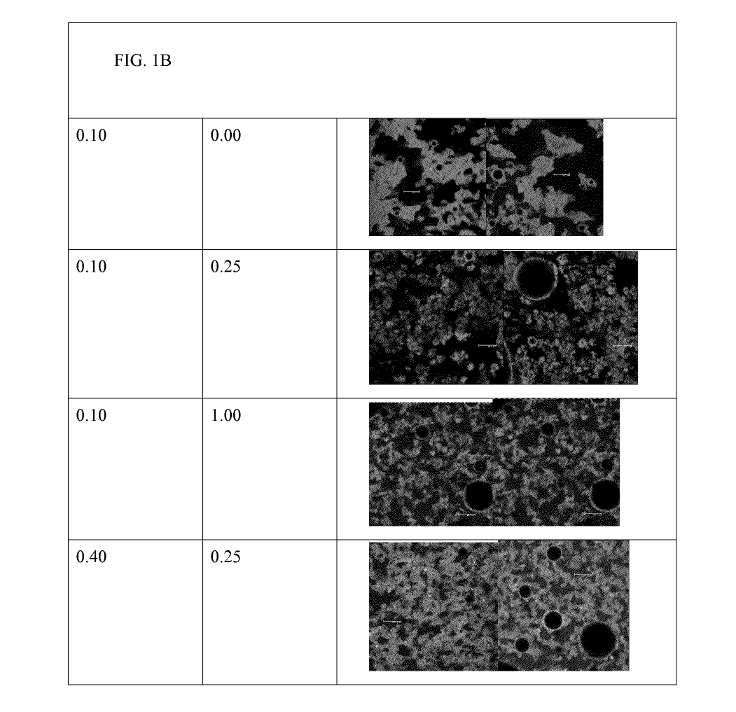

### Confocal: FIGS. 1A and 1B.

Microscope cover glasses (22×40 mm) were coated on one side with 40 μL of a mixture of 0.008% each of Fast Green FCF and Nile Red stains and 10% polyvinylpyrrolidone (10,000 molecular weight) in ethanol. The ethanol was allowed to evaporate, forming a dry film containing the fluorescent stains. Using a sharp blade, a small piece of frozen ice cream weighing about 0.1 g was placed on a microscope slide. This was allowed to melt at ambient temperature while covering with a stained cover glass, squashing the ice cream between the slide and cover glass.

Imaging was done with a 40× dry air objective on a Leica SPE II upright confocal microscopy system. For the channel shown in red, a 532 nm green laser was used, and the fluoresced light from 540-690 nm was collected. The green channel (fast green fluorescence) used a 635 nm red laser, gathering the fluoresced light from 670-800 nm. These channels were imaged in sequence, and combined for the final images. Some waiting time, generally 5-20 minutes, was required before flow of the liquid specimen on the slide stabilized to the point where the sequential images were well aligned.

The images show either a smooth and fluid protein network or a rough and rigid structure associated with protein agglomeration. All of the variables with tapioca starch demonstrated a more rigid protein structure except the 0.25% level with 0.015% pectin. The more rigid protein structure is correlated with high barometric shrinkage resistance, as all of the variables demonstrating the structure are correlated with shrinkage levels below 5%.

Tapioca starch is responsible for a rigid protein structure in the serum phase. The formation of this structure and the protection against barometric shrinkage seem to be correlated. Pectin has a much greater effect on ice cream texture than tapioca starch. Ice cream with higher levels of pectin were less icy, less cold, and slower melting. A combination of Tapioca starch and pectin allows for good air stability at the freezer and through barometric pressure changes, as well as providing optimum texture.

1. A stabilizer system of natural ingredients for use in frozen aerated confection, the stabilizer system comprising 0.25-2.0 wt. % of tapioca starch, and 0.05-0.40 wt. %.

2. A stabilizer system according to claim 1, comprising 0.3-1.5 wt. % tapioca starch and 0.1-0.40 wt. % pectin.

3-4. (canceled)

5. A frozen aerated confection comprising a stabiliser system comprising 0.25-2.0 wt. % of tapioca starch, and 0.05-0.40 wt. % pectin.

6. A frozen aerated confection according to claim 5, wherein the frozen aerated confection has 35-45 wt. % solid content and 95 to 135%, preferably 100 to 126% overrun.

7. A frozen aerated confection according to claim 5, wherein the frozen aerated confection is free of any artificial or non-natural emulsifier or stabilizer.

8. A frozen aerated confection according to claim 5, which is free of egg.

9. A frozen aerated confection according to claim 5, wherein the stabiliser system consists of tapioca starch and pectin.

10. A frozen aerated confection according to claim 5, which has a fat content of 3.0-11.0 wt. %.

11. Frozen aerated confectionery product according to claim 5, wherein the tapioca starch is native tapioca starch.

12. Frozen aerated confectionery product according to claim 5, consisting of only natural ingredients.

13. Frozen aerated confectionery product according to claim 5, wherein the product further comprises a pH adjusting agent to obtain a pH in the range of 5.0 to 6.5.

14. Method for the manufacture of a frozen aerated confectionery according to claim 5 comprising the steps of:
a) providing an ingredient mix comprising 0.25-2.0 wt. % of tapioca starch, and 0.05-0.40 wt. % pectin, and having a 35-45 wt. % solid content,
b) homogenising the mix,
c) pasteurising the mix, and
d) freezing and aerating the mix to 95 to 135%, preferably 100 to 130% to form a frozen confection.

15. A method according to claim 9, wherein the mix is further cooled to a temperature below −11° C. in a screw extruder.

16. A method according to claim 14, wherein the ingredient mix further comprises a pH adjusting agent to obtain a pH in the range of 5.0 to 6.5.
